(19) United States
(12) Patent Application Publication
(10) Pub. No.: US 2006/0121224 A1
(43) Pub. Date: Jun. 8, 2006

(54) Article having high barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/293,942

(22) Filed: Dec. 5, 2005

(30) Foreign Application Priority Data
Dec. 7, 2004 (KR) 10-2004-0102214
Apr. 22, 2005 (KR) 10-2005-0033527

(51) Int. Cl. B32B 27/08; B32B 1/08

(52) U.S. Cl. 428/35.7; 428/36.91

(57) ABSTRACT

An article having a barrier property is provided. The article includes a nanocomposite having a barrier property dispersed in a specific form in a polyolefin resin and has a fluorine-coated inner wall to have superior mechanical strength and form a strong barrier to oxygen, organic solvent, and moisture.

### CROSS-REFERENCE TO RELATED PATENT APPLICATION

This application claims the benefit of Korean Patent Application No. 10-2004-0102214, filed on Dec. 7, 2004, and Korean Patent Application No. 10-2005-0033527, filed on Apr. 22, 2005, in the Korean Intellectual Property Office, the disclosures of which are incorporated herein in their entirety by reference.

### BACKGROUND OF THE INVENTION

1. Field of the Invention

The present invention relates to an article having a high barrier property and having an inner wall coated with fluorine, in which a nanocomposite of an intercalated clay and a resin having a barrier property is dispersed in a specific form in a polyolefin resin matrix.

2. Description of the Related Art

General-purpose resins, such as polyethylene and polypropylene, are used in many fields due to their superior moldability, mechanical properties, and moisture barrier property. However, these resins are limited in their use in packaging or containers for agrochemicals and foods, which require superior chemical and oxygen barrier properties. Therefore, general-purpose resins are used for packaging or containers for such materials with other resins as multiple layers by co-extrusion, lamination, coating, etc.

An ethylene-vinyl alcohol (EVOH) copolymer and polyamide resins are used for multi-layered plastic products due to their transparency and good gas barrier property. However, because an ethylene-vinyl alcohol copolymer and polyamide resins are more expensive than general-purpose resins, a resin composition having a good barrier property even when small amounts of these resins are used is required.

Meanwhile, when a nano-sized intercalated clay is mixed with a polymer compound to form a fully exfoliated, partially exfoliated, intercalated, or partially intercalated nanocomposite, it has improved barrier properties due to its morphology. Thus, an article having a barrier property using such a nanocomposite is emerging.

It is important for the nanocomposite to maintain its fully exfoliated, partially exfoliated, intercalated, or partially intercalated morphology even after being molded and fully exfoliated morphology is advantageous in the improvement of a barrier property. In particular, when a molded article is prepared from a composition of the nanocomposite and a matrix polymer, the morphology of the nanocomposite dispersed in the matrix polymer is also important to improve a barrier property.

Meanwhile, to improve solvent and vapor barrier properties of polyethylene and other polymers used in containers having a barrier property, fluorine coating on an inner wall of a molded article is often used. Such a method is disclosed in U.S. Pat. No. 2,811,468 A (Joffre) and U.S. Pat. No. 3,862,284 A (Dixon, et al.). In U.S. Pat. No. 2,811,468 A, polyethylene is first fluorinated at room temperature to have an improved barrier property as a material for packaging foods and waste matter. In this patent, a method of manufacturing a blow molded container is also described in which a reactive fluorine containing fluid medium is used to conform a molten polyethylene parison to the contour of a mold. In this method, a polyethylene film and a container wall are fluorinated in a chamber by contacting a polyethylene surface with a fluorine containing gas at room temperature for 20 to 150 minutes such that the concentration of fluorine is 0.03 to 3.5 wt % based on the weight of polyethylene. U.S. Pat. No. 3,862,284 A discloses a method of producing blow molded thermoplastic articles having improved barrier properties through fluorination. In this method, a reactive gas containing an inert gas and 0.1 to 10% by volume of fluorine is injected into a parison to expand the parison into a desired shape. The injection takes about 5 seconds and is performed at a high temperature. Then, the parison is cooled to recover the reactive gas and a container is obtained. A fuel tank having a good barrier property to hydrocarbon, commercially available with the trade name Airopak, is manufactured using a blow molding method. In said method, a parison is expanded with an inert gas, and then degassed. Thereafter, a reactive gas containing 0.1 to 10 wt % of fluorine is injected into the parison to form the parison into a desired shape. Then, the reactive gas is removed from the parison and the resulting container is removed from a mold. Since the high temperature blow molding method of Dixon et al. was developed, many blow molding methods has been developed, and some are disclosed in, for example, U.S. Pat. No. 4,830,810 A, U.S. Pat. No. 4,617,077 and U.S. Pat. No. 4,869,859. The fluorine coating can improve the barrier property of a container since fluorine coated on the container prevents the penetration of materials. In a container made of polyethylene and coated with fluorine, the thickness of the coating layer is being increased in order to meet stricter environmental regulation. When the fluorine coating layer thickness is large, the fluorine coating layer in fuel tanks or filler pipes in which contents are frequently exchanged may be gradually removed over a long period of time due to a frequent exchange of contents, resulting in a reduction in the barrier property. Since this problem became known, the use of the fluorine coating in fuel tanks for vehicles or filler pipes has dramatically reduced.

### SUMMARY OF THE INVENTION

The present invention provides a fluorine-coated article having superior mechanical strength and superior oxygen, organic solvent, and moisture barrier properties, in which a nanocomposite is dispersed in a specific form in a matrix polymer and maintains its exfoliated morphology even after being molded. The article is manufactured using a composition having a good barrier property and has a thin fluorine-coating layer. The article prevents permeation and penetration of contents due to the good barrier property of its inner wall even when the fluorine-coating is released.

According to an aspect of the present invention, there is provided an article having a barrier property and a fluorine-coated inner wall, manufactured from a dry-blended composition including: 40 to 96 parts by weight of a polyolefin resin; 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer.

According to another aspect of the present invention, there is provided a method of manufacturing the article having a barrier property, including: preparing a nanocomposite composition having a barrier property by dry blending 40 to 96 parts by weight of a polyolefin resin, 0.5 to 60 parts by weight of a nanocomposite having a barrier property, including an intercalated clay and at least one resin having a barrier property selected from the group consisting of an ethylene-vinyl alcohol (EVOH) copolymer, a polyamide, an ionomer and a polyvinyl alcohol (PVA), and 1 to 30 parts by weight of a compatibilizer; molding the composition to form an article; and coating an inner wall of the molded article with fluorine.

In an embodiment of the present invention, the polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

In another embodiment of the present invention, the intercalated clay may be at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one compound selected from an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer.

In another embodiment of the present invention, the thickness of the fluorine coating layer may be 0.01 to 8 mm.

In another embodiment of the present invention, the fluorine-coating may be performed using a high temperature blow molding method.

### DETAILED DESCRIPTION OF THE INVENTION

The present invention will now be explained in more detail.

An article having a barrier property according to an embodiment of the present invention is prepared from a dry-blended composition including: 40 to 96 parts by weight of a polyolefin resin; 0.5 to 60 parts by weight of a nanocomposite having a barrier property, including intercalated clay and at least one resin having a barrier property, selected from the group consisting of an ethylene-vinyl alcohol (EVOH) copolymer, a polyamide, an ionomer and a polyvinyl alcohol (PVA); and 1 to 30 parts by weight of a compatibilizer and has a fluorine-coated inner wall.

The polyolefin resin may include at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

The content of the polyolefin resin is preferably 40 to 96 parts by weight, and more preferably 70 to 85 parts by weight. If the content of the polyolefin resin is less than 40 parts by weight, molding is difficult. If the content of the polyolefin resin is greater than 96 parts by weight, the barrier property is poor.

The nanocomposite having a barrier property may be prepared by mixing an intercalated clay with at least one resin selected from the group consisting of an ethylene-vinyl alcohol (EVOH) copolymer, a polyamide, an ionomer and a polyvinyl alcohol (PVA). The prepared nanocomposite has a fully exfoliated, partially exfoliated, intercalated, or partially intercalated morphology.

The weight ratio of the resin having a barrier property to the intercalated clay in the nanocomposite is 58.0:42.0 to 99.9:0.1, and preferably 85.0:15.0 to 99.0:1.0. If the weight ratio of the resin having a barrier property to the intercalated clay is less than 58.0:42.0, the intercalated clay agglomerates and dispersing is difficult. If the weight ratio of the resin having a barrier property to the intercalated clay is greater than 99.9:0.1, the improvement in the barrier properties is negligible.

The intercalated clay is preferably organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult. The organic material has at least one functional group selected from the group consisting of primary ammonium to quaternary ammonium, phosphonium, maleate, succinate, acrylate, benzylic hydrogen, oxazoline, and dimethyldistearylammonium.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, oxazoline, and dimethyidistearylammonium.

If an ethylene-vinyl alcohol copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

The amorphous polyamide refers to a polyamide having insufficient crystallinity, that is, not having an endothermic crystalline melting peak when measured by a differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1,5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using aliphatic diamine and aliphatic dicarboxylic acid is general semicrystalline polyamide (also referred to as crystalline nylon) and is not amorphous polyamide. Polyamide prepared using aromatic diamine and aromatic dicarboxylic acid is not easily treated using a general melting process.

Thus, amorphous polyamide is preferably prepared, when one of diamine and dicarboxylic acid used is aromatic and the other is aliphatic. Aliphatic groups of the amorphous polyamide are preferably C₁-C₁₅ aliphatic or C₄-C₈ alicyclic alkyls. Aromatic groups of the amorphous polyamide are preferably substituted C₁-C₆ mono- or bicyclic aromatic groups. However, all the above amorphous polyamide is not preferable in the present invention. For example, metaxylenediamine adipamide is easily crystallized when heated during a thermal molding process or when oriented, therefore, it is not preferable.

Examples of preferable amorphous polyamides include hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, a copolymer of hexamethylenediamine or 2-methylpentamethylenediamine and an isophthalic acid, terephthalic acid or mixtures thereof. While polyamide based on hexamethylenediamine isophthalamide/terephthalamide, which has a high terephthalic acid content, is useful, it should be mixed with another diamine such as 2-methyldiaminopentane in order to produce an amorphous polyamide that can be processed.

The above amorphous polyamide comprising only the above monomers may contain a small amount of lactam, such as caprolactam or lauryl lactam, as a comonomer. It is important that the polyamide be amorphous. Therefore, any comonomer that does not crystallize polyamide can be used. About 10 wt % or less of a liquid or solid plasticizer, such as glycerole, sorbitol, or toluenesulfoneamide (Santicizer 8 monsanto) can also be included in the amorphous polyamide. For most applications, a glass transition temperature Tg (measured in a dried state, i.e., with a water content of about 0.12 wt % or less) of amorphous polyamide is about 70-170° C., and preferably about 80-160° C. The amorphous polyamide, which is not blended, has a Tg of approximately 125° C. in a dried state. The lower limit of Tg is not clear, but 70° C. is an approximate lower limit. The upper limit of Tg is not clear, too. However, when polyamide with a Tg of about 170° C. or greater is used, thermal molding is difficult. Therefore, polyamide having both an acid and an amine having aromatic groups cannot be thermally molded due to too high Tg, and thus, is not suitable for the purposes of the present invention.

The polyamide may also be a semicrystalline polyamide. The semicrystalline polyamide is generally prepared using lactam, such as nylon 6 or nylon 11, or an amino acid, or is prepared by condensing diamine, such as hexamethylenediamine, with dibasic acid, such as succinic acid, adipic acid, or sebacic acid. The polyamide may be a copolymer or a terpolymer such as a copolymer of hexamethylenediamine/adipic acid and caprolactame (nylon 6, 66). A mixture of two or more crystalline polyamides can also be used. The semicrystalline and amorphous polyamides are prepared by condensation polymerization well-known in the art.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably 4 to 30 parts by weight. If the content of the nanocomposite is less than 0.5 part by weight, an improvement of barrier properties is negligible. If the content of the nanocomposite is greater than 60 parts by weight, processing is difficult.

The finer the intercalated clay is exfoliated in the resin having barrier property in the nanocomposite, the better the barrier properties that can be obtained. This is because the exfoliated intercalated clay forms a barrier film and thereby improves barrier properties and mechanical properties of the resin itself, and ultimately improves barrier properties and mechanical properties of a molded article prepared from the composition. Accordingly, the ability to form a barrier to gas and liquid is maximized by compounding the resin having a barrier property and the intercalated clay, and dispersing the nano-sized intercalated clay in the resin, thereby maximizing the contact area of the polymer chain and the intercalated clay.

The compatibilizer improves the compatibility of the polyolefin resin in the nanocomposite to form a molded article with a stable structure.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite having a barrier property, thereby obtaining a molded article with a stable structure.

The compatibilizer can include an compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) polypropylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

The content of the compatibilizer is preferably 1 to 30 parts by weight, and more preferably 3 to 15 parts by weight. If the content of the compatibilizer is less than 1 part by weight, the mechanical properties of a molded article from the composition are poor. If the content of the compatibilizer is greater than 30 parts by weight, the molding of the composition is difficult.

When an epoxy-modified polystyrene copolymer is used as the compatibilizer, a copolymer comprising a main chain which comprises 70 to 99 parts by weight of styrene and 1 to 30 part by weight of an epoxy compound represented by Formula 1, and branches which comprise 1 to 80 parts by weight of acrylic monomers represented by Formula 2, is preferable. 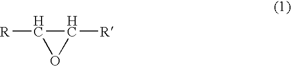
where each of R and R′ is independently a C₁-C₂₀ aliphatic residue or a C₅-C₂₀ aromatic residue having double bonds at its termini

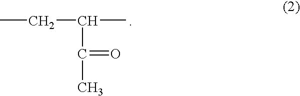

Each of the maleic anhydride modified (graft) high-density polyethylene, maleic anhydride modified (graft) polypropylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the main chain. When the content of the maleic anhydride is less than 0.1 part by weight, it does not function as the compatibilizer. When the content of the maleic anhydride is greater than 10 parts by weight, it is not preferable due to an unpleasant odor.

The composition of the present invention is prepared by dry-blending the nanocomposite having a barrier property in a pellet form, the compatibilizer and the polyolefin resin at a constant compositional ratio in a pellet mixer.

An article having a high barrier property according to the present invention is obtained by molding the dry-blended composition and coating an inner wall of the molded container with fluorine.

That is, the method includes: preparing a nanocomposite composition having a barrier property by dry blending 40 to 96 parts by weight of a polyolefin resin, 0.5 to 60 parts by weight of a nanocomposite having a barrier property, including an intercalated clay and at least one resin having a barrier property, selected from the group consisting of an ethylene-vinyl alcohol (EVOH) copolymer, a polyamide, an ionomer and a polyvinyl alcohol (PVA), and 1 to 30 parts by weight of a compatibilizer; molding the composition to form an article; and coating an inner wall of the molded article with fluorine.

The article having a high barrier property is manufactured from the dry-blended nanocomposite composition by molten-blending the composition in extruder and molding the molten-blend, and then coating an inner wall of the molded article with fluorine. The article may be manufactured through blow molding, extrusion molding, pressure molding or injection molding.

The article having a high barrier property may be a container, a sheet, a film, or a pipe.

Fluorine-coating can be performed using a high temperature blow molding method (Koyutakahukikomi molding method) and the thickness of the fluorine coating layer may be 0.02 to 11 μm. The fluorine-coated wall prevents penetration of contents before they contact the nanocomposite composition of which the container is primarily composed. Even when contents penetrate the fluorine-coated wall, the outer wall composed of the nanocomposite composition prevents penetration of contents, thereby showing a superior barrier property.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 500 (KP Chemicals)

Ionomer: SURLYN 8527 (Dupont, U.S.A.)

HDPE-g-MAH: Compatibilizer, PB3009 (CRAMPTON)

Polyolefin resin: High-density polyethylene (BDO 390, LG CHEM, melt index: 0.3 g/10 min, density: 0.949 g/cm³)

Clay: Closite 30B (SCP)

Thermal stabilizer: IR 1098 (Songwon Inc.)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; Φ40). Then, 3 wt % of organic montmorillonite (Southern Intercalated Clay Products, USA; C2OA) as an intercalated clay and 0.1 part by weight of IR 1098 as a thermal stabilizer based on total 100 parts by weight of the EVOH copolymer and the organic montmorillonite was separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 40 kg/hr.

### Preparation Example 2

(Preparation of Nylon 6/Intercalated Clay Nanocomposite)

97 wt % of a polyamide (nylon 6) was put in the main hopper of a twin screw extruder (SM Platek co-rotation twin screw extruder; Φ40). Then, 3 wt % of organic montmorillonite as an intercalated clay and 0.1 part by weight of IR 1098 as a thermal stabilizer based on total 100 parts by weight of the polyamide and the organic montmorillonite was separately put in the side feeder of the twin screw extruder to prepare a polyamide/intercalated clay nanocomposite in a pellet form.

The extrusion temperature condition was 220-225-245-245-245-245-245° C., the screws were rotated at 300 rpm, and the discharge condition was 40 kg/hr.

### Preparation Example 3

(Preparation of lonomer/Intercalated Clay Nanocomposite)

97 wt % of an ionomer was put in the main hopper of a twin screw extruder (SM Platek co-rotation twin screw extruder; Φ40). Then, 3 wt % of organic montmorillonite as an intercalated clay and 0.1 part by weight of IR 1098 as a thermal stabilizer based on total 100 parts by weight of the ionomer and the organic montmorillonite was separately put in the side feeder of the twin screw extruder to prepare an ionomer/intercalated clay nanocomposite in a pellet form. The extrusion temperature condition was 220-225-245-245-245-245-245° C., the screws were rotated at 300 rpm, and the discharge condition was 40 kg/hr.

### Example 1

25 parts by weight of the EVOH/intercalated clay nanocomposite obtained in Preparation Example 1, 6 parts by weight of a compatibilizer, and 69 parts by weight of high-density polyethylene were dry-blended in a dumble mixer and the dry-blend was extruded using a blow molding machine (SMC blow machine 60 phi) under an extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the container was returned to atmospheric pressure state and removed from the mold. The resulting molded container had an inner wall with a 0.2 μm thick fluorine-coating.

### Example 2

25 parts by weight of the nylon 6/intercalated clay nanocomposite obtained in Preparation Example 2, 6 parts by weight of a compatibilizer, and 69 parts by weight of high-density polyethylene were dry-blended in a double cone mixer (MYDCM-100, MYEONG WOO MICRON SYSTEM) for 30 minutes. The dry-blend was extruded using a blow molding machine (SMC blow machine 60 phi) under the extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the container was returned into atmospheric pressure state and removed from the mold. The resulting molded container had an inner wall with a 0.2 μm thick fluorine-coating.

### Example 3

4 parts by weight of the nylon 6/intercalated clay nanocomposite obtained in Preparation Example 2, 2 parts by weight of a compatibilizer, and 94 parts by weight of high-density polyethylene were dry-blended in a double cone mixer (MYDCM-100, MYEONG WOO MICRON SYSTEM) for 30 minutes. The dry-blend was extruded using a blow molding machine (SMC blow machine 60 phi) under the extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the containerwas degassed for 1.5 seconds. Finally, the container was pressurized with inert nitrogen for 6 seconds to a pressure of about 100 psig (0.7 Mpa). Thereafter, the container was returned into atmospheric pressure state and removed from the mold. The resulting molded container had an inner wall with a 0.2 μm thick fluorine-coating.

### Example 4

40 parts by weight of the nylon 6/intercalated clay nanocomposite obtained in Preparation Example 2, 18 parts by weight of a compatibilizer, and 42 parts by weight of high-density polyethylene were dry-blended in a double cone mixer (MYDCM-100, MYEONG WOO MICRON SYSTEM) for 30 minutes. The dry-blend was extruded using a blow molding machine (SMC blow machine 60 phi) under the extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the container was returned into atmospheric pressure state and removed from the mold. The resulting molded container had an inner wall with a 0.2 μm thick fluorine-coating.

### Example 5

25 parts by weight of the ionomer/intercalated clay nanocomposite obtained in Preparation Example 3, 6 parts by weight of a compatibilizer, and 69 parts by weight of high-density polyethylene were dry-blended in a double cone mixer (MYDCM-100, MYEONG WOO MICRON SYSTEM) for 30 minutes. The dry-blend was extruded using a blow molding machine (SMC blow machine 60 phi) under the extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the container was returned into atmospheric pressure state and removed from the mold. The resulting molded container had an inner wall with a 0.2 μm thick fluorine-coating.

### Example 6

5 parts by weight of the nylon 6/intercalated clay nanocomposite obtained in Preparation Example 2, 7 parts by weight of a compatibilizer, and 78 parts by weight of high-density polyethylene were simultaneously put into a main hopper of a blow molding machine (SMC blow machine 60 phi) through belt-type feeders K-TRON Nos. 1, 2, and 3, respectively, in a dry-blend state and extruded under the extrusion temperature condition of 190-205-205-205° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the container was returned into atmospheric pressure state and removed from the mold. The resulting molded container had an inner wall with a 0.2 μm thick fluorine-coating.

### Comparative Example 1

A container having a barrier property was manufactured in the same manner as in Example 1, except that the organic montmorillonite as an intercalated clay was not used.

### Comparative Example 2

A container having barrier properties was manufactured in the same manner as in Example 2, except that the organic montmorillonite as an intercalated clay was not used.

### Comparative Example 3

Polyethylene (BD0390, LG CHEM) was extruded using a blow molding machine (SMC blow machine 60 phi) under the extrusion temperature condition of 185-195-195-195° C. A parison extruded from the end of the blow molding machine was put into a mold shaped as a 1000 mL agrochemical container. The parison was pressurized with an inert gas (nitrogen) for 6 seconds to a pressure of 100 psig. Then, the pressure in the container was reduced and the container was degassed for 1.5 seconds. Subsequently, the container was re-pressurized with a reactive gas containing nitrogen gas and 1 to 10% of fluorine gas for 6 seconds to a pressure of about 100 psig (0.7 Mpa). Thereafter, the pressure was released and the container was degassed for 1.5 seconds. Then, the container was re-pressurized with inert nitrogen for 6 seconds to a pressure of about 100 psig (0.7 Mpa). Thereafter, the pressure was released and the container was degassed for 1.5 seconds. Finally, the container was pressurized with inert nitrogen for 6 seconds to a pressure of about 100 psig (0.7 Mpa). Thereafter, the containerwas returned into atmospheric pressure state and removed from the mold. The resulting molded container had an inner wall with a 0.2 μm thick fluorine-coating.

### Experimental Example

a) Liquid Barrier Property

Toluene, Desys herbicide (1% of deltametrine+emulsifier, stabilizer, and solvent; Kyung Nong), Batsa insecticide (50% of BPMC+50% of emulsifier and solvent), and water were put in the containers manufactured in Examples 1 to 6 and Comparative Examples 1 to 3. Then, the weight change was determined after 30 days under a condition of forced exhaust at 50° C. For toluene, the weight change was further determined at room temperature.

b) Gas Barrier Property (cc/m²·day·atm)

The containers manufactured in Examples 1 to 6 and Comparative Examples 1 to 3 were left alone under a temperature of 23C and a relative humidity of 50% for 1 day. Then, the gas penetration rate was determined (Mocon OX-TRAN 2/20, U.S.A).

TABLE 1
Gas Barrier Property

| | Oxygen penetration | Moisture penetration |
|---|---|---|
| | (cm²/m² · 24 hrs · atm) | (g/m² · 24 hrs) |
| Example 1 | 5.3 | 1.04 |
| Example 2 | 2.5 | 1.05 |
| Example 3 | 9.6 | 0.98 |
| Example 4 | 1.83 | 1.01 |
| Example 5 | 11.1 | 1.02 |
| Example 6 | 1.96 | 1.02 |
| Comparative Example 1 | 35.4 | 1.32 |
| Comparative Example 2 | 34.8 | 1.26 |
| Comparative Example 3 | 56.4 | 2.03 |

TABLE 2
Liquid Barrier Property

| | Liquid barrier property(%) | | | | |
|---|---|---|---|---|---|
| | Weight | | | | |
| | change at | | | | |
| | 25° C. | Weight change at 50° C. | | | |
| Classification | Toluene | Toluene | Desys | Batsa | Water |
| Example 1 | 0.023 | 0.323 | 0.105 | 0.017 | 0.0011 |
| Example 2 | 0.008 | 0.088 | 0.061 | 0.019 | 0.0013 |
| Example 3 | 0.017 | 0.185 | 0.091 | 0.038 | 0.0010 |
| Example 4 | 0.003 | 0.056 | 0.052 | 0.009 | 0.0012 |
| Example 5 | 0.036 | 0.530 | 0.094 | 0.083 | 0.0013 |
| Example 6 | 0.003 | 0.057 | 0.054 | 0.011 | 0.012 |
| Comparative | 0.430 | 4.593 | 1.126 | 0.414 | 0.0021 |
| Example 1 | | | | | |
| Comparative | 0.623 | 5.279 | 1.312 | 0.235 | 0.0029 |
| Example 2 | | | | | |
| Comparative | 0.925 | 6.304 | 1.638 | 0.598 | 0.0031 |
| Example 3 | | | | | |

As shown in Tables 1 and 2, containers of Examples 1 to 6 have superior barrier properties to liquid and gas compared to those of Comparative Examples 1 to 3.

The article having a barrier property of the present invention has superior mechanical strength and forms a strong barrier to oxygen, organic solvent, and moisture.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An article having a barrier property and a fluorine-coated inner wall, prepared from a dry-blended composition comprising:
40 to 96 parts by weight of a polyolefin resin;
0.5 to 60 parts by weight of a nanocomposite having a barrier property, comprising an intercalated clay and at least one resin having a barrier property selected from the group consisting of an ethylene-vinyl alcohol (EVOH) copolymer, a polyamide, an ionomer and a polyvinyl alcohol (PVA); and
1 to 30 parts by weight of a compatibilizer.

2. The article having a barrier property of claim 1, wherein the weight ratio of the resin having a barrier property to the intercalated clay in the nanocomposite is 58.0:42.0 to 99.9:0.1.

3. The article having a barrier property of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

4. The article having a barrier property of claim 1, wherein the intercalated clay comprises 1 to 45 wt % of an organic material.

5. The article having a barrier property of claim 4, wherein the organic material has at least one functional group selected from the group consisting of primary ammonium to quaternary ammonium, phosphonium, maleate, succinate, acrylate, benzylic hydrogen, oxazoline, and dimethyldistearylammonium.

6. The article having a barrier property of claim 1, wherein the ethylene-vinyl alcohol copolymer contains 10 to 50 mol % of ethylene.

7. The article having a barrier property of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

8. The article having a barrier property of claim 7, wherein the glass transition temperature of the amorphous polyamide is about 80-130° C.

9. The article having a barrier property of claim 7, wherein the amorphous polyamide is selected from the group consisting of hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, and a copolymer of hexamethylenediamine or 2-methylpentamethylenediamine and isophthalic acid, terephthalic acid, or a mixture thereof.

10. The article having a barrier property of claim 9, wherein the amorphous polyamide is hexamethylene diamine isophthalamide/terephthalamide terpolymer having a ratio of isophthalic acid to terephthalic acid of 70:30.

11. The article having a barrier property of claim 1, wherein the ionomer has a melt index of 0.1 to 10 g/10 min (190° C., 2,160 g).

12. The article having a barrier property of claim 1, wherein the compatibilizer is one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

13. The article having a barrier property of claim 1, which is a container, a film, a pipe, or a sheet.

14. The article having a barrier property of claim 1, wherein the thickness of the fluorine coating layer is 0.02 to 11 μm.

15. A method of manufacturing the article having a barrier property and a fluorine coated inner wall, comprising:
preparing a nanocomposite composition having a barrier property by dry-blending 40 to 96 parts by weight of a polyolefin resin, 0.5 to 60 parts by weight of a nanocomposite having a barrier property, comprising an intercalated clay and at least one resin having a barrier property selected from the group consisting of an ethylene-vinyl alcohol (EVOH) copolymer, a polyamide, an ionomer and a polyvinyl alcohol (PVA), and 1 to 30 parts by weight of a compatibilizer;
molding the composition to form an article; and
coating an inner wall of the molded article with fluorine.

16. The method of claim 15, wherein the fluorine-coating is performed using a high temperature blow molding method.

17. The method of claim 15, which is manufactured through blow molding, extrusion molding, pressure molding, or injection molding.
